(19) United States
(12) Patent Application Publication
(10) Pub. No.: US 2017/0273479 A1
(43) Pub. Date: Sep. 28, 2017

(54) Frame Hanging Assist Device

(71) Applicant: Joshua Snyder, Dripping Springs, TX (US)

(72) Inventor: Joshua Snyder, Dripping Springs, TX (US)

(21) Appl. No.: 15/077,360

(22) Filed: Mar. 22, 2016

(51) Int. Cl. A47G 1/20; B25H 7/04; A47G 1/17

(52) U.S. Cl. CPC A47G 1/205; A47G 1/17; B25H 7/04

(57) ABSTRACT

A frame hanging assist device for correctly positioning mounting hardware for hanging a frame includes a plurality of markers. Each marker comprises a head coupled to a first end of a shaft. The head is configured to reversibly couple to a hanging bracket of a frame to couple the marker to the hanging bracket. When coupled, the marker extends substantially perpendicularly from the frame. A tip is coupled to a second end of the shaft. The tip is configured to leave an indicium on a wall. The markers are reversibly couplable to the frame. When the frame bearing the markers is positioned adjacent to the desired hanging location on the wall, the tips are configured to contact the wall leaving indicia designating the correct points to mount anchors on the wall to hang the frame from the wall.

BACKGROUND OF THE DISCLOSURE

### Field of the Disclosure

The disclosure relates to hanging devices and more particularly pertains to a new hanging device for correctly positioning mounting hardware for hanging a frame.

### SUMMARY OF THE DISCLOSURE

An embodiment of the disclosure meets the needs presented above by generally comprising a plurality of markers. Each marker comprises a head coupled to a first end of a shaft. The head is configured to reversibly couple to a hanging bracket of a frame to couple the marker to the hanging bracket. When coupled, the marker extends substantially perpendicularly from the frame. A tip is coupled to a second end of the shaft. The tip is configured to leave an indicium on a wall. The markers are reversibly couplable to the frame. When the frame bearing the markers is positioned adjacent to the desired hanging location on the wall, the tips are configured to contact the wall leaving indicia designating the correct points to mount anchors on the wall to hang the frame from the wall.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a frame hanging assist device according to an embodiment of the disclosure.

FIG. 2 is a bottom view of an embodiment of the disclosure.

FIG. 3 is a side view of an embodiment of the disclosure.

FIG. 4 is an isometric perspective view of an embodiment of the disclosure.

FIG. 5 is an in-use view of an embodiment of the disclosure.

### DESCRIPTION OF THE PREFERRED EMBODIMENT

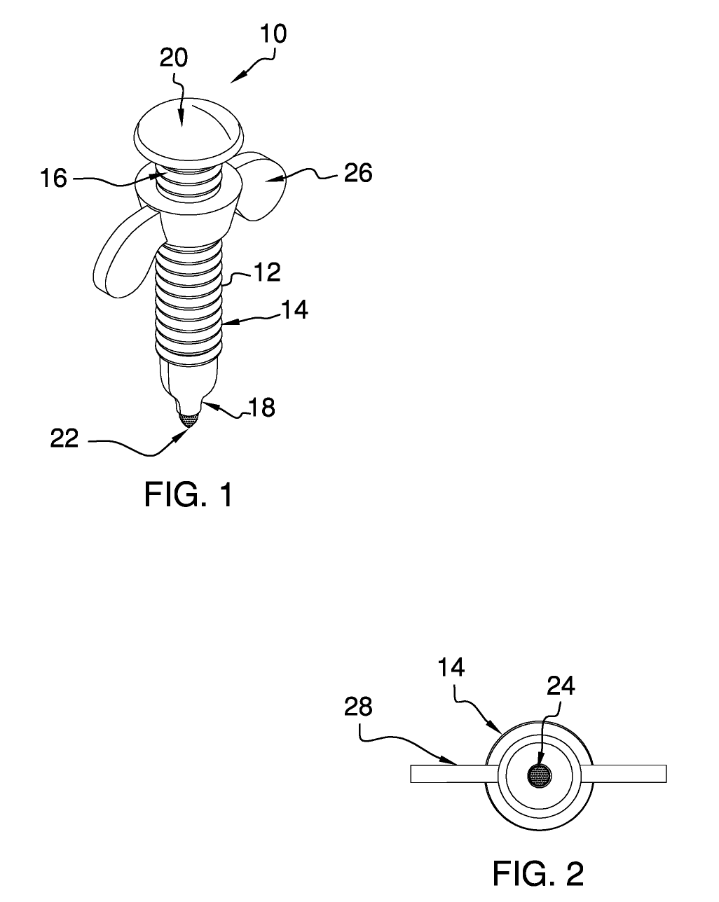

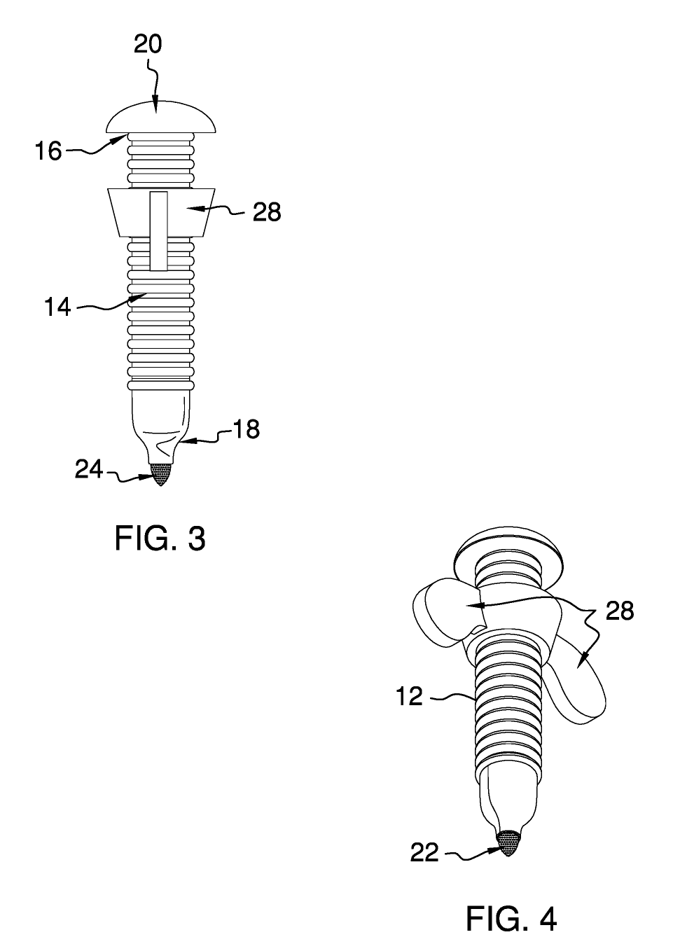

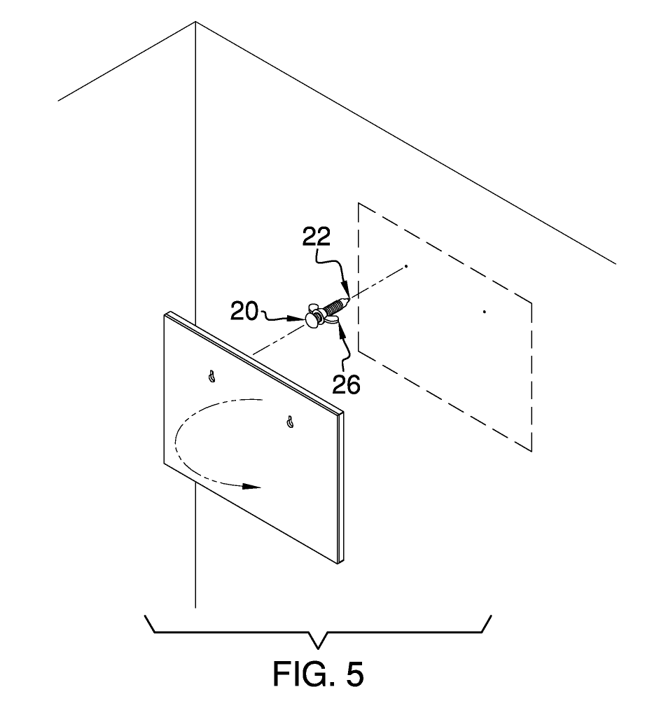

With reference now to the drawings, and in particular to FIGS. 1 through 5 thereof, a new hanging devices embodying the principles and concepts of an embodiment of the disclosure and generally designated by the reference numeral 10 will be described.

As best illustrated in FIGS. 1 through 5, the frame hanging assist device 10 generally comprises a plurality of markers 12. Each marker 12 comprises a shaft 14 that has a first end 16 and a second end 18. The shaft 14 is tapered adjacent to the second end 18. Preferably, the shaft 14 is cylindrical and threaded.

A head 20 is coupled to the first end 16 of a shaft 14. The head 20 is configured to reversibly couple to a hanging bracket of a frame to couple the marker 12 to the frame. When coupled to the frame, the marker 12 extends substantially perpendicularly from the frame. Preferably, the head 20 is substantially circular. More preferably, the head 20 is magnetic, such that the head 20 is configured to magnetically couple to the hanging bracket.

A tip 22 is coupled to the second end 18 of the shaft 14. The tip 22 is configured to leave an indicium on a wall. Preferably, the tip 22 is pointed. More preferably, the tip 22 comprises a felt tip 24, such that the felt tip 24 is configured to render an indicium on the wall.

A coupler 26 is variably positionable on the shaft 14. The coupler 26 is configured to tighten, such that the hanging bracket is fixedly positioned between the coupler 26 and the head 20. Preferably, the coupler 26 comprises a wing nut 28 that is threadedly positionable on the shaft 14. The wing nut 28 is configured to tighten to couple the hanging bracket between the wing nut 28 and the head 20.

The present invention also anticipates a plurality of caps. Each cap is couplable to the second end 18 of a respective shaft 14 to seal the tip 22 when the marker 12 is not in use.

In use, the markers 12 are reversibly couplable to the frame. When the frame bearing the markers 12 is positioned adjacent to the desired hanging location on the wall, the tips 22 are configured to contact the wall leaving indicia designating the correct points to mount anchors on the wall to hang the frame from the wall.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. Frame hanging assist device comprising:
a plurality of markers, each said marker comprising:
a head coupled to a first end of a shaft, said head being configured to reversibly couple to a hanging bracket of a frame to couple said marker to the frame, such that said marker extends substantially perpendicularly from the frame, and
a tip coupled to a second end of said shaft, said tip being configured to leave an indicium on a wall, and;
wherein said markers are reversibly couplable to the frame, such that, when the frame bearing said markers is positioned adjacent to the desired hanging location on the wall, said tips are configured to contact the wall leaving indicia designating the correct points for mounting anchors on the wall to hang the frame from the wall.

2. The device of claim 1, further including said shaft being tapered adjacent to said second end.

3. The device of claim 1, further including said tip being pointed.

4. The device of claim 3, further including said tip comprising a felt tip, wherein said felt tip is configured to render an indicium on the wall.

5. The device of claim 1, further including a coupler, said coupler being variably positionable on said shaft, wherein said coupler is configured for tightening such that the hanging bracket is fixedly positioned between said coupler and said head.

6. The device of claim 5, further including said shaft being cylindrical.

7. The device of claim 6, further comprising:
said shaft being threaded;
said coupler comprising a wing nut; and
wherein said wing nut is threadedly positionable on said shaft such that said wing nut is configured for tightening to couple the hanging bracket between said wing nut and said head.

8. The device of claim 1, further including said head being substantially circular.

9. The device of claim 1, further including said head being magnetic, wherein said head is configured to magnetically couple to the hanging bracket.

10. Frame hanging assist device comprising:
a plurality of markers, each said marker comprising:
a shaft having a first end and a second end, said shaft being tapered adjacent to said second end, said shaft being cylindrical, said shaft being threaded,
a head coupled to said first end of said shaft, said head being configured to reversibly couple to a hanging bracket of a frame to couple said marker to the frame, such that said marker extends substantially perpendicularly from the frame, said head being substantially circular, said head being magnetic, wherein said head is configured to magnetically couple to the hanging bracket, and
a tip coupled to said second end of said shaft, said tip being configured to leave an indicium on a wall, said tip being pointed, said tip comprising a felt tip, wherein said felt tip is configured to render an indicium on the wall;
a coupler, said coupler being variably positionable on said shaft, wherein said coupler is configured for tightening such that the hanging bracket is fixedly positioned between said coupler and said head, said coupler comprising a wing nut, wherein said wing nut is threadedly positionable on said shaft such that said wing nut is configured for tightening to couple the hanging bracket between said wing nut and said head, and;
wherein said markers are reversibly couplable to the frame, such that, when the frame bearing said markers is positioned adjacent to the desired hanging location on the wall, said tips are configured to contact the wall leaving indicia designating the correct points for mounting anchors on the wall to hang the frame from the wall.
